(19) United States
(12) Patent Application Publication
(10) Pub. No.: US 2020/0175016 A1
(43) Pub. Date: Jun. 4, 2020

(54) OPTIMIZATION OF DATABASE QUERIES WITH MULTIPLE HETEROGENEOUS DATABASE SYSTEMS

(71) Applicant: Teradata US, Inc., Dayton, OH (US)

(72) Inventors: Sanjay Nair, El Segundo, CA (US); Sreyas Srimath Tirumala, Los Angeles, CA (US); Nurjahan Begum, Bellevue, WA (US); Chandana Prakash, Seattle, WA (US); Mohammed Al-Kateb, Rolling Hills Estates, CA (US); Conrad Kwok-Wai Tang, Torrance, CA (US); Mohamed Yassin Eltabakh, Worcester, MA (US); Kassem Awada, Torrance, CA (US); Grace Kwan-On Au, Rancho Palos Verdes, CA (US)

(73) Assignee: Teradata US, Inc., Dayton, OH (US)

(21) Appl. No.: 16/225,009

(22) Filed: Dec. 19, 2018

Related U.S. Application Data
(60) Provisional application No. 62/773,140, filed on Nov. 29, 2018.

(51) Int. Cl. G06F 16/2453; G06F 16/27

(52) U.S. Cl. CPC G06F 16/24537; G06F 16/27; G06F 16/24542

(57) ABSTRACT

Multiple cost models (e.g., a sub-operations costing model and logical-operations costing model) can be used to make cost estimations of execution of database queries in one and each one of the multiple heterogeneous database systems. As a result, a “hybrid” cost estimating mode can be used whereby two or more cost models can be used in a single database system in to order maximize the advantages and minimize the disadvantages of each of the cost models, thereby striving to achieve an optimal balance. In addition, cost estimation can be switched between a hybrid cost estimating mode and a single cost estimating mode. The switch can, for example, be made as a part of tuning phase, as more information about actual costs of execution of database queries becomes more available, or as a result of changes to the database system and/or it operations, and so on. As a result, a flexible cost estimating mechanism can also be provided.

### CROSS-REFERENCE TO RELATED APPLICATIONS

This application claims priority under 35 U.S.C. § 119(e) to the following co-pending and commonly-assigned patent application, which is incorporated herein by reference: U.S. Provisional Patent Application No. 62/773,140, entitled: “OPTIMIZATION OF DATABASE QUERIES WITH MULTIPLE HETEROGENEOUS DATABASE SYSTEMS,” by Mohamed Eltabkh et al., on Nov. 29, 2018, which is hereby incorporated herein by reference, in its entirety and for all purposes.

### BACKGROUND

Today, the term “data” is widely used. In the context of computing environments and system, data can generally encompass of all forms of information. The information can, for example, be stored in a computer readable medium (e.g., memory, hard disk). Data, and in particular, one or more instances of data, can also be referred to as data object(s). As is generally known in the art, a data object can for example, be an actual instance of data, a class, type, or form data, and so on.

The term database can refer to a collection of data and/or data structures typically stored in a digital form. Data can be stored in a database for various reasons and to serve various entities or “users.” Generally, data stored in the database can be used by the database users. A user of a database can, for example, be a person, a database administrator, a computer application designed to interact with a database, etc. A very simple database or database system can, for example, be provided on a Personal Computer (PC) by storing data on a Hard Disk (e.g., contact information) and executing a computer program that allows access to the data. The executable computer program can be referred to as a database program or a database management program. The executable computer program can, for example, retrieve and display data (e.g., a list of names with their phone numbers) based on a request submitted by a person (e.g., show me the phone numbers of all my friends in San Diego).

Generally, database systems are much more complex than the example noted above. In addition, databases have been evolved over the years and some databases that are for various business and organizations (e.g., banks, retail stores, governmental agencies, universities) in use today can be very complex and support several users simultaneously by providing very complex queries (e.g., give me the name of all customers under the age of thirty five (35) in Ohio that have bought all items in a list of items in the past month in Ohio and also have bought ticket for a baseball game in San Diego and purchased a baseball in the past 10 years).

Typically, a Database Manager (DM) or a Database Management System (DBMS) is provided for relatively large and/or complex databases. As known in the art, a DBMS can effectively manage the database or data stored in a database and serve as an interface for the users of the database. A DBMS can be provided as an executable computer program (or software) product as is also known in the art.

It should also be noted that a database can be organized in accordance with a Data Model. Notable Data Models include a Relational Model, an Entity-relationship model, and an Object Model. The design and maintenance of a complex database can require highly specialized knowledge and skills by database application programmers, DBMS developers/programmers, database administrators (DBAs), etc. To assist in design and maintenance of a complex database, various tools can be provided, either as part of the DBMS or as free-standing (stand-alone) software products. These tools can include specialized Database languages (e.g., Data Description Languages, Data Manipulation Languages, Query Languages). Database languages can be specific to one data model or to one DBMS type. One widely supported language is Structured Query Language (SQL) developed, by in large, for Relational Model and can combine the roles of Data Description Language, Data Manipulation language, and a Query Language.

Today, databases have become prevalent in virtually all aspects of business and personal life. Moreover, database use is likely to continue to grow even more rapidly and widely across all aspects of commerce. Generally, databases and DBMS that manage them can be very large and extremely complex partly in order to support an ever increasing need to store data and analyze data. Typically, larger databases are used by larger organizations. Larger databases are supported by a relatively large amount of capacity, including computing capacity (e.g., processor and memory) to allow them to perform many tasks and/or complex tasks effectively at the same time (or in parallel). On the other hand, smaller databases systems are also available today and can be used by smaller organizations. In contrast to larger databases, smaller databases can operate with less capacity.

A popular type of database is the relational Database Management System (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One important aspect of database systems is optimization of the database queries of the data stored in the database as it is generally appreciated by those skilled in the art.

In view of the ever-increasing need for database systems in various computing environments and systems, improved techniques for optimization of database queries would be very useful.

### SUMMARY

Broadly speaking, the invention relates to computing systems and computing environments. More particularly, the invention pertains to techniques for estimating the cost estimating cost of execution of one or more database queries in a database environment. The techniques are especially suited database environment that includes multiple database systems with differing characteristics (multiple heterogeneous database systems).

In accordance with one aspect, at least two different cost models (e.g., a sub-operations costing model and logical-operations costing model) can be used to make cost estimations of execution of database queries in one and each one of the multiple heterogeneous database systems. As a result, a “hybrid” cost estimating mode can be used whereby two or more cost models can be used in a single database in to order maximize the advantages and minimize the disadvantages of each of the cost models, thereby striving to achieve an optimal balance.

In accordance with one aspect, cost estimation can be switched between a hybrid cost estimating mode and a single cost estimating mode. In the single cost estimating mode only one cost estimation model can be used. The switch can, for example, be made as a part of tuning phase, as more information about actual costs of execution of database queries becomes more available, or as a result of changes to the database system and/or it operations, and so on. As a result, a flexible cost estimating mechanism can also be provided.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1 depicts a cost estimating system in a heterogeneous database environment 100 in accordance with one embodiment.

FIG. 2 depicts a multi-system unified architecture augmented with the proposed HCE module in accordance with one embodiment.

FIG. 3 provides a comparison between Sub-Op and Logical-Op Training with respect to a few considerations in accordance with one or more embodiments.

FIGS. 4A-4C depict profiles that can be provided in accordance with some exemplary embodiments.

FIG. 5 depicts a method for estimating the cost of a remote operation in accordance with one embodiment.

FIG. 6 depicts a method for of estimating cost of execution of at least a part of one or more database queries in a database environment in accordance with one embodiment.

### DETAILED DESCRIPTION

As noted in the background section, improved techniques for optimization of database queries would be very useful.

In some database systems, including big data ecosystems, it is becoming inevitable to query data from multiple heterogeneous data sources (or remote systems) to build meaningful querying and analytical workflows. Although such interconnectivity and interoperability create unprecedented opportunities for advanced analytics and data sciences, they can pose numerous technical challenges. This is because the number of the remote system types is increasing dramatically, each system has unique inherent characteristics and processing capabilities, some systems are open boxes while others are black boxes—with many levels in between, and each system offers different levels of sophistications with respect to query optimization. Therefore, building a unified architecture with a centralized optimizer to efficiently orchestrate the overall processing across systems is very important.

Some conventional database systems (e.g., Presto) decide on distributing the execution plan across the remote systems based on heuristics or default configuration values, but not based on cost-based analysis. Other conventional database systems (e.g., BIGDAWG Polystore are cost based but they rely on statistics collected solely from logical-op level training, which has several drawbacks including very high overheads and lengthy training phase. Yet other conventional systems (e.g., Polybase) can be customized only to query specific remote systems, namely relational databases and Hadoop. On the other hand, other conventional database systems (e.g., LEO-DB2) can offer a learning optimizer that learns and adjusts the cost of its operators but only within the relational database engine, i.e., it does not execute across remote and heterogeneous database systems. Still other conventional systems (e.g., Damia) primarily focus on data integration across multiple data sources. However, data integration is typically an offline batch process that is distinct from ad-hoc SQL-Like execution plans that need be optimized in heterogeneous database systems.

It would be very useful to have the ability to handle ad-hoc SQL-Like execution plans that can span multiple remote and heterogeneous systems and require cost-based estimation to decide on the optimal overall plan. In the regard, the speed, efficient, and robustness of an optimizer that can operate in database environments that span multiple remote and heterogeneous systems would be very useful. The optimizer would be able to learn the execution cost of remote operations.

It will be appreciated that, at least two different cost models (e.g., a sub-operations costing model and logical-operations costing model) can be used to make cost estimations of execution of database queries in one and each one of the multiple heterogeneous database systems, in accordance with one aspect. As a result, a “hybrid” cost estimating mode can be used whereby two or more cost models can be used in a single database in to order maximize the advantages and minimize the disadvantages of each of the cost models, thereby striving to achieve an optimal balance.

In accordance with one aspect, cost estimation can be switched between a hybrid cost estimating mode and a single cost estimating mode. In the single cost estimating mode only one cost estimation model can be used. The switch can, for example, be made as a part of tuning phase, as more information about actual costs of execution of database queries becomes more available, or as a result of changes to the database system and/or its operations, and so on. As a result, a flexible cost estimating mechanism can also be provided

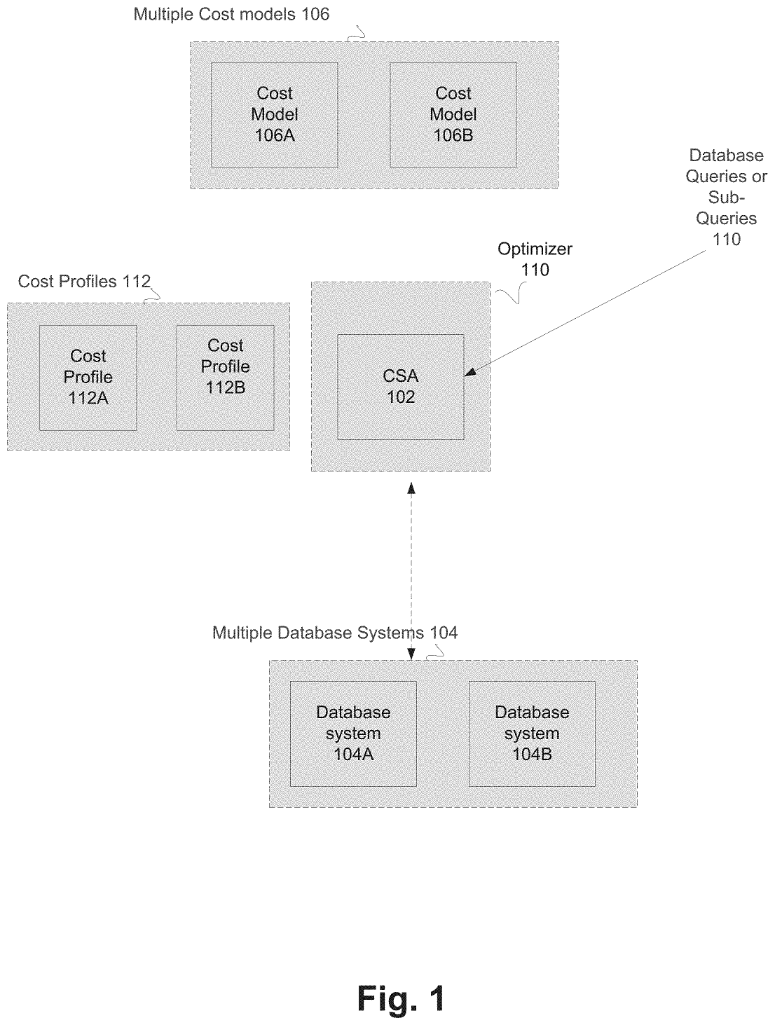

Some Embodiments are also discussed below with reference to FIGS. 1 through 6. However, those skilled in the art will readily appreciate that the detailed description given herein with respect to these figures is for explanatory purposes as the invention extends beyond these limited embodiments.

FIG. 1 depicts a cost estimating system (CSA) 102 in a heterogeneous database environment 100 in accordance with one embodiment. Referring to FIG. 1, multiple database systems 104 can be provided in the heterogeneous database environment 100 such that a first database 104A can be different from a second database 104B. It will be appreciated that the cost estimating system 102 can effectively serve as a flexible unifying cost estimation mechanism. As such, the cost estimating system 102 can, for example, be provided as a part of unifying mechanism for optimization database queries in a multi-system unfired architecture as described in greater detail below.

It should be noted that in multi-system unfired architecture, it is generally desirable to optimize the execution of database queries with respect to multi-database systems 104 collectively. In other words, it is desirable to determine the optimal manner that a database query can be executed given the resources of each one of the database systems 104. For example, in some cases it may be optimal to run (or execute) a database query entirely on a database system 104A, whereas it may be optimal to run another database query in a database system 104B, but it may be optimal to run part of a yet another database query on the database system 104A while running another part of the database query on the database system 104B, and so on. As such, it is important to determine the cost of running various parts of a database query (or sub-query) on different database systems.

Referring back to FIG. 1, cost estimating system 102 can function as a unifying cost estimator in the heterogeneous database environment 100, in accordance with one embodiment. In doing so, cost estimating system 102 can consider and use multiple cost models 106 such that a single of a combination of two of more models are considered and/or used for a particular database system (e.g., 104A) of the multiple database systems to estimate the cost of execution of one or more database queries or sub-queries.

Generally, the cost estimating system 102 can determine whether to use only one of multiple cost models 106 to estimate the cost of execution of the one or more database queries or sub-queries 110 by one of the multiple database systems, for example, the database system 104A. This determination can be made based on various characteristics of the database system (e.g., open or closed database system) and/or other requirements (availability of cost formulas, time allowed for estimating the cost). For example, various considerations can, include whether the database system is an Open box or Closed box system and to what degree, as well as training time that can be devoted to learning the cost. Other exemplary considerations can include availability of knowledge pertaining to cost (e.g., type of physical (or lower) operators and cost formulas on higher (or logical) level database operators).

Referring back to FIG. 1, if the cost estimating system 102 determines to use only one of the cost models 106 (e.g., cost model 106A) to estimate the cost of execution of the one or more database queries or sub-queries 110 by a particular database system of the multiple database systems (e.g., the database system 104A), then the cost models 106 can proceed to use only one of the cost models 106 (e.g., cost model 106A) determined to be suitable by itself for cost estimation to estimate the cost of execution of the one or more database queries or sub-queries 110 by the particular database system of the multiple database systems under consideration (e.g., the database system 104A). Similarly, the cost estimating system 102 can proceed to make the same determination for another one of the database systems (e.g., database system 104B). As a result, the cost estimating system 102 may or may not determine to use only one the cost models for estimation of the cost of execution one or more database queries or sub-queries 110 by the other database system (e.g., database system 104B). In cases when the cost estimating system 102 determines to use only one of the cost models 106 (e.g., 104A, 104B) to estimate the cost of the execution of the one or more database queries or sub-queries 110 by a particular one of the database systems 106, the cost estimating system 102 can initiate the cost estimation by using only one cost models 106 for that particular database system of the multiple database systems 106. The cost estimation that uses only one the cost models 106 can, for example, be performed by using a convention cost estimation technique as those skilled in the art will readily appreciate. However, it should be noted that at later time the cost estimating system 102 can determine whether to switch the cost estimation model being used to another one or a combination of two or more cost models of the cost models 106 in accordance with one aspect.

In accordance with another aspect, the cost estimating system 102 can determine not to use only one of the cost models 106 (e.g., 104A, 104B) to estimate the cost of the execution of the one or more database queries or sub-queries 110 by a particular one of the database systems. This determination can be made initially or a later time (e.g., as part of reevaluation of tuning process). In such cases, the cost estimating system 102 can use at least two of the multiple cost models 106 to estimate the cost of the execution of the one or more database queries or sub-queries 110 by a particular one of the database systems 104. In other words, the cost estimating system 102 can determine to use two or more costs models (e.g., 106A and 106B) to estimate the cost of execution of the one or more database queries or sub-queries 110 in a single database system 106 (e.g., 106A). As will be described in greater detail, in effect, a hybrid mode can be initialed by the cost estimating system 102 such that more than one cost models can be utilized to estimate the cost of execution of the one or more database queries or sub-queries 110 in a single one of the database systems 106 (e.g., 106A). For example, in a hybrid mode, a first cost model 106A (e.g., “Logical-Op costing” model) can be used to estimate the cost of execution of one or more database operations DBOPi (e.g., an “aggregation” database operation”) of the database system 104A and a second cost model 106B (e.g., a “Sub-op Costing” model) can be used to estimate the cost of another one or more database operations DBOPj (e.g., a “Join” database operation) of the same database system, namely database system 104A.

As another example, in a hybrid mode, two or more cost models (e.g., 106A and 106B) can be used to estimate a particular database operation (e.g., DBOi) of a particular database system 104A. By way of example, for a “join” database operator different physical algorithms can be used in different modes to estimate the cost of the “Join” database operator.

The determination of whether to use only one of the cost models 106 or use more than one of the cost models 106 in a hybrid mode can, for example, be performed based on the cost profiles 112, where a cost profile 112A can be provided for a database system 104A, whereas a cost profile 112B can be provided for a database system 104B and so on in accordance with another aspect. A cost profile 112A can, for example, provide information indicative of how to estimate costs for various database operations (e.g., which one the cost model or models 106 are to be used to estimate the cost a particular one or more database operations of a particular database system 104) as will be described in greater detail below. A cost profile 112A can, for example, provided as a configuration file that is obtained by the cost estimating system 102 or it may be effectively generated by the cost estimating system 102 based on one more considerations that can detected and/or provided as input. In effect, the cost estimating system 102 can initiate a cost profiling process (or phase, or stage) where the cost profile of a particular database system (e.g., database system 104A) is obtained (e.g., received, read, determined, generated). As a result, the cost of execution of execution of the one or more database queries or sub-queries 110 in a single database system 106 (e.g., 106A) can be initiated in accordance to a cost profile 112 in a single or hybrid cost estimating mode where more than one cost models 106 are used to estimate the cost of execution of execution of the one or more database queries or sub-queries 110 in a single database system 106 (e.g., 106A).

After the cost profiling process has been initiated and successfully completed, the cost estimating system 102 can effectively initiate a second process, namely, a training process, where the costs of the execution of the one or more database queries or sub-queries 110 can be estimated and stored. As a result, two or more cost models 106 can be used to estimate execution costs of the one or more database queries or sub-queries 110 in a hybrid mode in accordance with one aspect.

In addition, it should be noted that cost estimating system 102 can effectively initiate a tuning process where the estimated costs can be compared with actual execution costs that can, for example, be incrementally collected. As a result, the tuning process, the cost estimating system 102 may effectively change one or more cost profiles 106 such that a particular cost model 106 that is currently used is changed to a different one of the different cost models 106.

Those skilled in the art will also readily know and appreciate that the cost estimating system 102 can, for example, be implemented by hardware or software, or a combination thereof. For example, although not shown in FIG. 1, the cost estimating system 102 can be implemented as a computer (or computing system) provided by one or more physical processors that execute executable compute code stored in a non-transitory computer readable medium (e.g., memory). The estimating system 102 can also be provided as a part of an database optimizer or optimizing system.

In accordance with one or more aspects, it will also be appreciated that a the cost estimating system 102 can, for example be provided using a learning-based cost estimation approach that can offer useful abilities including:

i) Providing a hybrid mechanism that enables cost estimation at both coarse-granular logical-op level (e.g., join and aggregation) and fine-granular sub-op level (e.g., scan and re-distribute). Each of the two cost estimation techniques can have a number of advantages and disadvantages (pros and cons). Also, each can be better suited for a specific database system at a given point in time. As such, a hybrid mechanism can aim at combining the advantages of both sides.

ii) Providing high interoperability to communicate with and learn from both lack box (or blackbox) and open box (or openbox) remote systems. This interoperability is essential for scalability and accommodating a wide spectrum of remote systems.

iii) Speeding up the learning curve by reducing the training time and overhead. This can be achieved by the hybrid mechanism and its ability to switch between the logical-op and sub-op levels whenever appropriate, which can help to speed up learning and effectively shrink the training phase.

iv) Boosting database query performance by allowing for better cost estimation for remote operators.

Cost-based query optimization is essential for achieving high performance in database systems. For example, assume a join operation between one local table in a local database system (e.g., a Teradata database system) and a remote table in a remote database system, then the query optimizer needs to estimate the cost of either sending the local table to the remote database system and performing the join remotely or bringing the remote table to local database system and performing the join locally. Such cost estimation is feasible only if the optimizer has accurate and reliable cost estimates for each of the remote database systems.

In accordance with one aspect, a Hybrid Cost Estimation learning system (or module) (“HCE”) can be provided. HCE can reside inside the connector of each remote system. To further elaborate, a HCE is further described with respect to two cost estimating techniques, namely sub-op training and logical-op training in a multi-system unified environment.

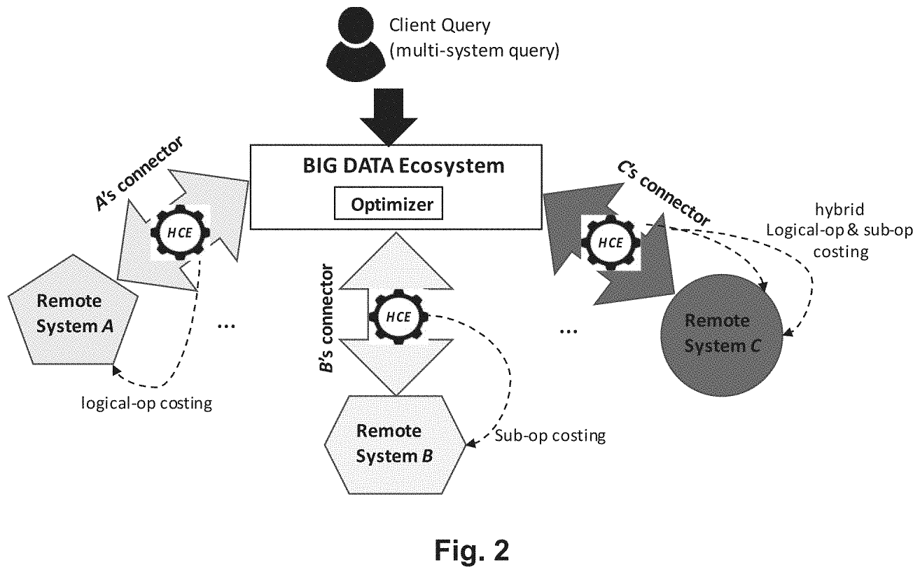

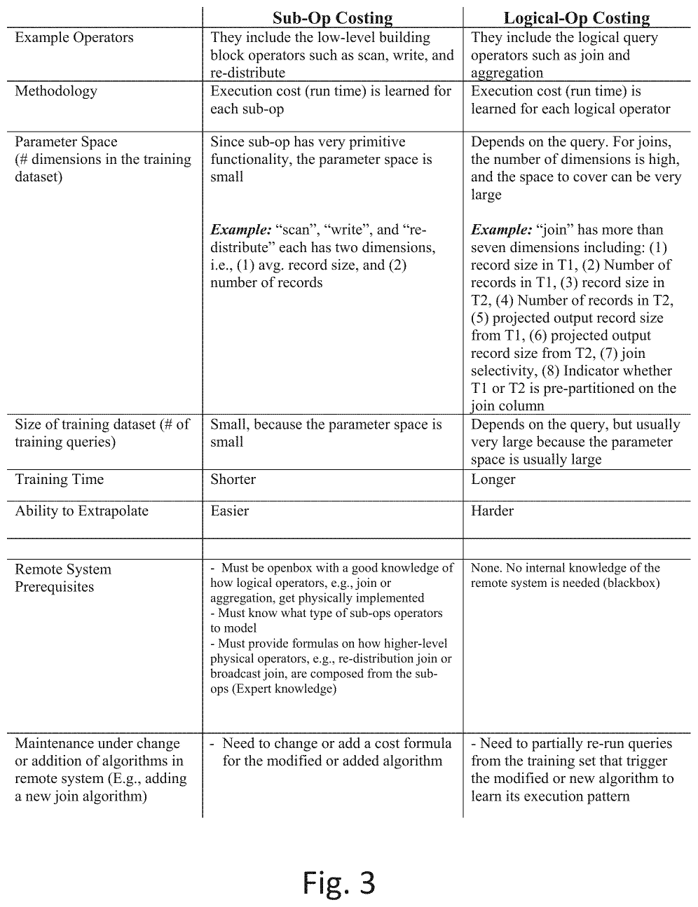

In particular, FIG. 2 depicts a multi-system unified architecture augmented with the proposed HCE module in accordance with one embodiment. Depending on the characteristics of the remote system, (e.g., blackbox vs. openbox) the HCE module may enable cost estimation based on logical-op training (as is the case with Remote System A), sub-op training (as is the case with Remote System B), or based on the combination of both modes (as is the case with Remote System C). Each of the two modes can offer some advantages or drawbacks (pros and cons). The HCE can be used in an effort to maximize the advantages by combining the two approaches of the two modes of operation. FIG. 3 provides a comparison between Sub-Op and Logical-Op Training with respect to a few considerations.

HCE Costing Profile

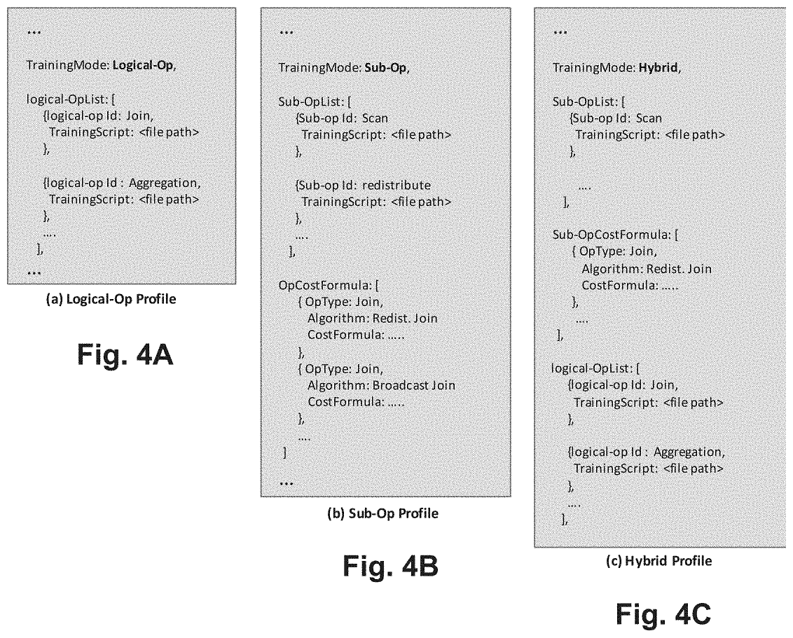

In one embodiment, a HCE can maintain a profile for each one of remote database systems as part of the corresponding connector. FIGS. 4A-4C depict profiles that can be provided in accordance with some exemplary embodiments. A field in the profile can be used to indicate the training mode, i.e., ‘TrainingMode’. If the mode is ‘Logical-Op’ (FIG. 4A), then one more field is needed to specify the list of modeled remote logical operators and the location of the corresponding training script (that contains the training queries for that operator), i.e., ‘logical-OpList’.

If the mode is ‘Sub-Op’ (FIG. 4B), then a list of the sub-ops to be modeled is defined in the ‘Sub-OpList’ field along with the training script for each sub-op. Moreover, an additional field ‘OpCostFormula’ is needed to include the cost formula for the different DB physical operators (e.g., the different join algorithms, in terms of the trained sub-ops.

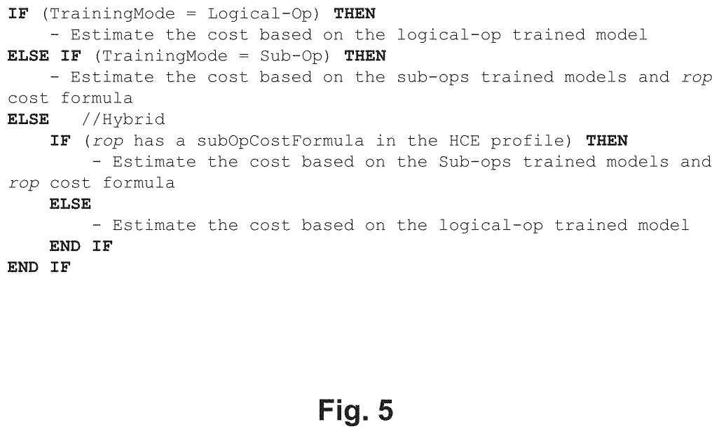

A third mode, hybrid mode (FIG. 4C) can be very beneficial, for example, when the query-level mode is rather expensive to cover the entire parameter space while the operator-level mode requires an extensive knowledge of the domain that is not fully available. In this case, the profile (C) contains a subset of the known building block operators (not necessary a comprehensive list), and the cost formula of the corresponding operations that will be estimated using building block operators. Moreover, the profile has a field specifying the location of the query-level training script. In the hybrid mode, different database (DB) operators can be trained under different modes (e.g., an aggregation operator is trained using query-level training while a join operator is trained using operator-level training. In addition, for the same operator (e.g., join) different physical algorithms can be trained in different modes. A hybrid approach can be flexible and balance between the extensive domain knowledge needed to model the building block operators and the extensive training effort needed to cover all possibilities in training complex operators. FIG. 5 depicts a method for estimating the cost of a remote operation. It should be noted that training phase can example, be performed by making scripts and submitting them to a remote database system.

HCE Training Phase

After building the costing profile for each remote system. HCE can perform a learning-based training phase (e.g., offline learning-based training phase). In this phase, HCE can decide based on the profile configurations which mode to operate under and in turn which script to submit for execution over the remote system. The collected execution costs can then be used to build a model using, for example, machine learning or deep learning techniques. The learned models can be at the sub-op, logical-op, or both levels depending on the training mode of the remote system.

HCE in Optimization Phase

In compilation and optimization phases of a given query, each operator in the query plan that may execute on a remote system (e.g., rop) can have its cost estimated as follows (assuming the remote database table(s) cardinalities and data statistics are already available).

HCE Progressive Tuning Phase

HCE can operate continuously under a tuning phase (e.g., the background). The execution costs of the completed remote operators can be incrementally collected and compared with the estimated costs. This can help to detect anomalies (e.g., miss-estimated costs), to refine the built costing models, and potentially to learn which mode (sub-op or logical-op) may work better for a given remote database system.

As disparate data sources start to permeate large data ecosystems, sophisticated cost estimation models become an indispensable part of the query processing engines to achieve high performance. The significant advantages of one or more embodiments can include ease of implementation into any existing commercial or open source database optimization infrastructure. The integration of the query and operator-levels costing methods as a hybrid model can be holistic approach. It can be designed for specialists and novices to automate or customize dynamic data source interactions effortlessly.

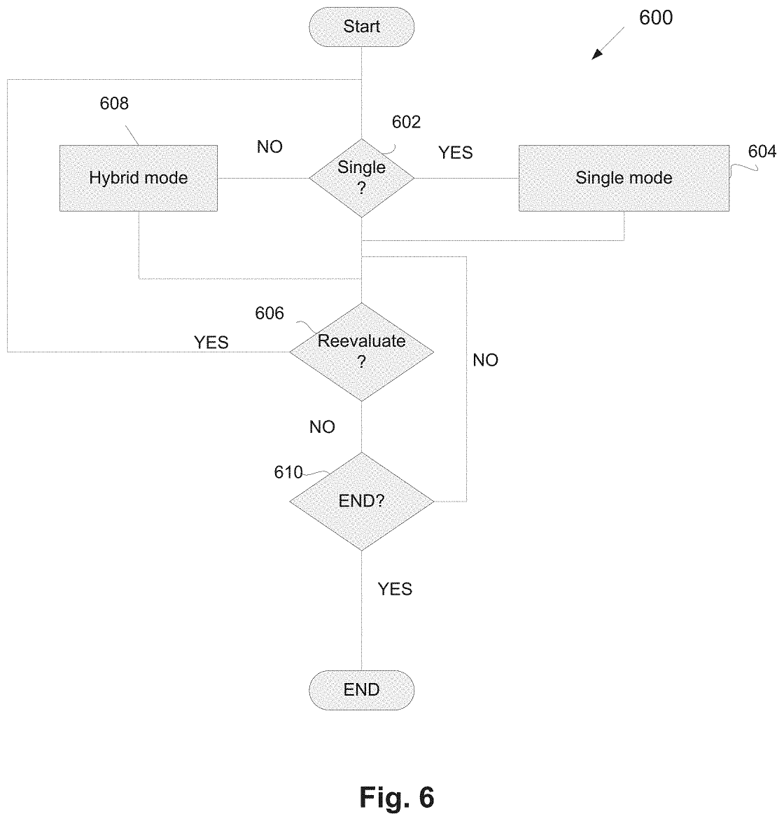

To elaborate even further, FIG. 6 depicts a method 600 for of estimating cost of execution of at least a part of one or more database queries in a database environment in accordance with one embodiment. It should be noted that the database environment multiple database systems with different characteristics. Also, there are multiple cost models available to estimate the cost of execution of one or more database queries in the database environment. Method 600 can be used to estimating the cost of execution of one or more database queries in each one of the multiple database systems.

Referring to FIG. 6, initially, it is determined (602) whether to use only one of multiple cost models to estimate the cost of execution of at least a part of one or more database queries by a first one of the multiple database systems. The termination (602) can, for example, be made based on one or more of the following: whether the first one of the multiple database systems is an open or closed system, whether the first one of the multiple database systems is more of an open than a closed system, a determined or pre-determined desired time for obtaining cost estimations of the cost of execution of at least a part of one or more database queries, and availability of cost information needed to initiate estimating the cost of execution of at least a part of one or more database queries.

As another example, the determination can be made based on a cost profile that can, for example, be generated by a database administrator and effectively provided as input to the method 600.

In any case, if it is determined (602) to use only one of multiple cost models to estimate the cost of execution of at least a part of the one or more database queries by a first one of the multiple database systems, only one the multiple cost models is used (604) to estimate the cost of execution of at least a part of the one or more database queries in a single cost estimation mode. Thereafter, the method 600 can proceed to determine (606) whether to reevaluate the determination (602) and continue in this manner to either use only one of the multiple cost models (single mode) or use (608) at least two of the cost models in a hybrid mode if the determination (602) determines not to use only one cost model to estimate the cost of execution of at least a part of the one or more database queries. The revaluating (606) can, for example, be performed as part of a tuning process (or phase) where the estimated cost is compared with actual cost obtained. For example, a cost profile can be used to initially estimate the cost, then the estimated cost can be compared with an actual cost later obtained in order to determine to change the cost profile to effectively switch between from a single mode to a hybrid mode or vice versa, or switch from a cost estimation model to another one for one or more particular database operations.

By way of example, in a hybrid mode (608), a first cost model can be used to estimate the cost of a first one of multiple database operations defined for a first one of the multiple database systems, and a second cost model can be used to estimate the cost of a second one of multiple database operations defined for the same database system. As another example, a first and a second cost model can be used to estimate the cost of a first database operation (e.g., a database join operation” defined for the first one of the multiple database systems, for example, by using a different physical operator (or implementation) of the database operation for each one of the cost models, respectively. Method 600 ends when the determining (610) determines to end the cost estimating method 600, for example, as a result of database system shutdown.

The various aspects, features, embodiments or implementations described above can be used alone or in various combinations. For, example, implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, tactile or near-tactile input.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described is this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A device, comprising:
memory; and
one or more processors configured to:
access the memory;
determine whether to use only one of multiple cost models to estimate the cost of execution of at least a part of one or more database queries by a first one of multiple database systems;
use only one the multiple cost models to estimate the cost of execution of at least a part of the one or more database queries when the determining to use only one of multiple cost models to estimate the cost of execution of at least a part of the one or more database queries by a first one of the multiple database systems;
use at least two of the multiple cost models to estimate the cost of execution of at least a part of the one or more database queries when the determining determines not to use only one of multiple cost models to estimate the cost of execution of the one or more database queries by a first one of the multiple database systems.

2. The device of claim 1, wherein the using the least two of the multiple cost models to estimate the cost of execution of the at least part of the one or more database queries further comprises:
using a first cost model to estimate the cost of a first one of multiple database operations defined for the first one of the multiple database systems; and
using a second cost model to estimate the cost of a second one of multiple database operations defined for the first one of the multiple database systems, wherein the first one of multiple database operations is different from the second one of multiple database operations.

3. The device of claim 1, wherein the using the least two of the multiple cost models to estimate the cost of execution of the at least part of the one or more database queries further comprises:
using at least a first cost model and a second cost model of the multiple cost models to estimate the cost of execution a first one of multiple database operations defined for the first one of the multiple database systems to determine at least first and second cost estimates for the first one of multiple database operations determined respectively by using the first and second cost models.

4. The device of claim 3, wherein the determining of the first and second cost estimates for the first one of multiple database operations further comprises: using a different physical operators or implementations of the first one of the multiple database operations for each one of the first and second cost models.

5. The device of claim 1, wherein the determining of whether to use only one of multiple cost models to estimate the cost of execution of at least a part of one or more database queries by a first one of the multiple database systems is made at least based on one or more of the followings:
whether the first one of the multiple database systems is an open or closed system,
whether the first one of the multiple database systems is more of an open than a closed system,
a determined or pre-determined desired time for obtaining cost estimations of the cost of execution of at least a part of one or more database queries, and availability of cost information needed to initiate estimating the cost of execution of at least a part of one or more database queries.

6. The device of claim 1, wherein the one or more processors are further configured to:
determine whether to switch between a single cost estimation mode and a hybrid cost estimation mode, wherein in the single cost estimation mode, only one of the multiple cost models is used to estimate the cost of execution of at least a part of the one or more database queries, and wherein in the hybrid cost estimation mode, at least two of the multiple cost models are used to estimate the cost of execution of at least a part of the one or more database queries.

7. The device of claim 1, wherein the one or more processors are further configured to:
obtain a cost profile; and
use the cost profile to make the determining of whether to use only one of multiple cost models to estimate the cost of execution of at least a part of one or more database queries by a first one of multiple database systems.

8. The device of claim 7, wherein the one or more processors are further configured to:
initiate a training phase to calculate the cost of execution of at least a part of one or more database queries by a first one of multiple database systems by at least providing one more scripts to be executed remotely by the first one of multiple database systems.

9. The device of claim 7, wherein the one or more processors are further configured to:
initiate a tuning phase to determine whether to change the cost profile by at least comparing the calculated cost of the execution of at least a part of one or more database queries by the first one of multiple database systems with actual cost of the execution of at least a part of one or more database queries by the first one of multiple database systems.

10. The device of claim 1, wherein the multiple cost models include a logical-operation costing model and sub-operation costing model.

11. A computer-implemented method of estimating cost of execution of one or more database queries in a database environment that includes multiple database systems, the computer-implemented method comprising:
determining whether to use only one of multiple cost models to estimate the cost of execution of at least a part of one or more database queries by a first one of multiple database systems;
using only one the multiple cost models to estimate the cost of execution of at least a part of the one or more database queries when the determining to use only one of multiple cost models to estimate the cost of execution of at least a part of the one or more database queries by a first one of the multiple database systems;
using at least two of the multiple cost models to estimate the cost of execution of at least a part of the one or more database queries when the determining determines not to use only one of multiple cost models to estimate the cost of execution of the one or more database queries by a first one of the multiple database systems.

12. The computer-implemented method of claim 11, wherein the using the least two of the multiple cost models to estimate the cost of execution of the at least part of the one or more database queries further comprises:
using a first cost model to estimate the cost of a first one of multiple database operations defined for the first one of the multiple database systems; and
using a second cost model to estimate the cost of a second one of multiple database operations defined for the first one of the multiple database systems, wherein the first one of multiple database operations is different from the second one of multiple database operations.

13. The computer-implemented method of claim 11, wherein the using the least two of the multiple cost models to estimate the cost of execution of the at least part of the one or more database queries further comprises:
using at least a first cost model and a second cost model of the multiple cost models to estimate the cost of execution a first one of multiple database operations defined for the first one of the multiple database systems to determine at least first and second cost estimates for the first one of multiple database operations determined respectively by using the first and second cost models.

14. The computer-implemented method of claim 13, wherein the determining of the first and second cost estimates for the first one of multiple database operations further comprises:
using a different physical operators or implementations of the first one of the multiple database operations for each one of the first and second cost models.

15. The computer-implemented method of claim 11, wherein the computer implemented method further comprises:
determining whether to switch between a single cost estimation mode and a hybrid cost estimation mode, wherein in the single cost estimation mode, only one of the multiple cost models is used to estimate the cost of execution of at least a part of the one or more database queries, and wherein in the hybrid cost estimation mode, at least two of the multiple cost models are used to estimate the cost of execution of at least a part of the one or more database queries.

16. The computer-implemented method of claim 11, wherein the computer implemented method further comprises:
obtaining a cost profile; and
using the cost profile to make the determining of whether to use only one of multiple cost models to estimate the cost of execution of at least a part of one or more database queries by a first one of multiple database systems.

17. The computer-implemented method of claim 11, wherein the computer implemented method further comprises:
initiating a training phase to calculate the cost of execution of at least a part of one or more database queries by a first one of multiple database systems by at least providing one more scripts to be executed remotely by the first one of multiple database systems.

18. The computer-implemented method of claim 11, wherein the determining of whether to use only one of multiple cost models to estimate the cost of execution of at least a part of one or more database queries by a first one of the multiple database systems is made at least based on one or more of the followings:
whether the first one of the multiple database systems is an open or closed system,
whether the first one of the multiple database systems is more of an open than a closed system,
a determined or a pre-determined desired time for obtaining cost estimations of the cost of execution of at least a part of one or more database queries, and
availability of cost information needed to initiate estimating the cost of execution of at least a part of one or more database queries.

19. A non-transitory computer readable storage medium storing at least executable computer code the when executed estimates the cost of execution of one or more database queries in a database environment that includes multiple database systems, wherein the executable computer code includes:
executable computer code to determine whether to use only one of multiple cost models to estimate the cost of execution of at least a part of one or more database queries by a first one of multiple database systems;
executable computer code to use only one the multiple cost models to estimate the cost of execution of at least a part of the one or more database queries when the determining to use only one of multiple cost models to estimate the cost of execution of at least a part of the one or more database queries by a first one of the multiple database systems;
executable computer code to use at least two of the multiple cost models to estimate the cost of execution of at least a part of the one or more database queries when the determining determines not to use only one of multiple cost models to estimate the cost of execution of the one or more database queries by a first one of the multiple database systems.

20. The non-transitory computer readable storage medium of claim 19, wherein the executable computer code further includes:
executable computer code to determine whether to switch between a single cost estimation mode and a hybrid cost estimation mode, wherein in the single cost estimation mode, only one of the multiple cost models is used to estimate the cost of execution of at least a part of the one or more database queries, and wherein in the hybrid cost estimation mode, at least two of the multiple cost models are used to estimate the cost of execution of at least a part of the one or more database queries.
